(19) United States
(12) Patent Application Publication
(10) Pub. No.: US 2020/0014809 A1
(43) Pub. Date: Jan. 9, 2020

(54) PRINTER AND IMAGE FORMING METHOD

(71) Applicant: TOSHIBA TEC KABUSHIKI KAISHA, Tokyo (JP)

(72) Inventor: Yayoi Doi, Mishima Shizuoka (JP)

(73) Assignee: TOSHIBA TEC KABUSHIKI KAISHA, Tokyo (JP)

(21) Appl. No.: 16/028,955

(22) Filed: Jul. 6, 2018

(51) Int. Cl. H04N 1/00; G06F 3/12; H04N 1/60

(52) U.S. Cl. CPC H04N 1/00466; H04N 1/6022; G06F 3/1241; G06F 3/1219

(57) ABSTRACT

A printer includes a forming device configured to form images with non-decolorable printing material and decolorable printing material. The printer further includes an interface configured to acquire a document image and a memory configured to store an auxiliary image relating to post-processing. The printer additionally includes a controller configured to print the document image with the non-decolorable printing material on a medium by using the forming device, and print the auxiliary image with the decolorable printing material on the medium by using the forming device.

### FIELD

Embodiments described herein relate generally to a printer and an image forming method.

### BACKGROUND

A post-processing (finishing processing) such as a hole punching processing or a processing of folding a sheet in three may be performed after a printer forms an image on the sheet. If a user performs the finishing processing, it is necessary to align positions of punched holes or align folds, which takes much time and labor.

If the finishing processing is performed by a multi-function peripheral, the multi-function peripheral is necessarily provided with a post-processing apparatus for performing the finishing processing in addition to a printing device, resulting in an increase in cost.

### DESCRIPTION OF THE DRAWINGS

FIG. 1 is a block diagram illustrating an example of a configuration of an image forming apparatus according to at least one embodiment;

FIG. 2 is a diagram illustrating an example of a document image according to at least one embodiment;

FIG. 3 is a diagram illustrating a display example of an operation panel of the image forming apparatus according to at least one embodiment;

FIG. 4 is a diagram illustrating a display example of the operation panel of the image forming apparatus according to at least one embodiment;

FIG. 5 is a diagram illustrating an example of a sheet printed by the image forming apparatus according to at least one embodiment;

FIG. 6 is a diagram illustrating an example of the sheet printed by the image forming apparatus according to at least one embodiment;

FIG. 7 is a diagram illustrating a display example of the operation panel of the image forming apparatus according to at least one embodiment;

FIG. 8 is a diagram illustrating an example of the sheet printed by the image forming apparatus according to at least one embodiment;

FIG. 9 is a diagram illustrating an example of the document image according to at least one embodiment;

FIG. 10 is a diagram illustrating a display example of the operation panel of the image forming apparatus according to at least one embodiment;

FIG. 11 is a diagram illustrating an example of the sheet printed by the image forming apparatus according to at least one embodiment;

FIG. 12 is a diagram illustrating an example of the document image according to at least one embodiment;

FIG. 13 is a diagram illustrating a display example of the operation panel of the image forming apparatus according to at least one embodiment;

FIG. 14 is a diagram illustrating an example of the sheet printed by the image forming apparatus according to at least one embodiment;

FIG. 15 is a flowchart for depicting an example of an operation by the image forming apparatus according to at least one embodiment;

FIG. 16 is a flowchart for depicting an example of an operation by the image forming apparatus according to at least one embodiment; and

FIG. 17 is a flowchart for depicting an example of an operation by the image forming apparatus according to at least one embodiment.

### DETAILED DESCRIPTION

In accordance with at least one embodiment, a printer comprises a forming device configured to form images with non-decolorable printing material and decolorable printing material; an interface configured to acquire a document image; a memory configured to store an auxiliary image relating to post-processing; and a controller configured to print the document image with the non-decolorable printing material on a medium by using the forming device, and print the auxiliary image with the decolorable printing material on the medium by using the forming device.

Hereinafter, certain embodiments are described in detail with reference to the accompanying drawings.

According to at least one embodiment, an image forming apparatus prints a document image on a sheet (medium) according to an operation from a user. The image forming apparatus forms a toner image on the sheet according to the document image. The image forming apparatus heats a sheet on which a toner image is formed to fix the toner image on the sheet. The image forming apparatus outputs the sheet on which the toner image is fixed to the outside.

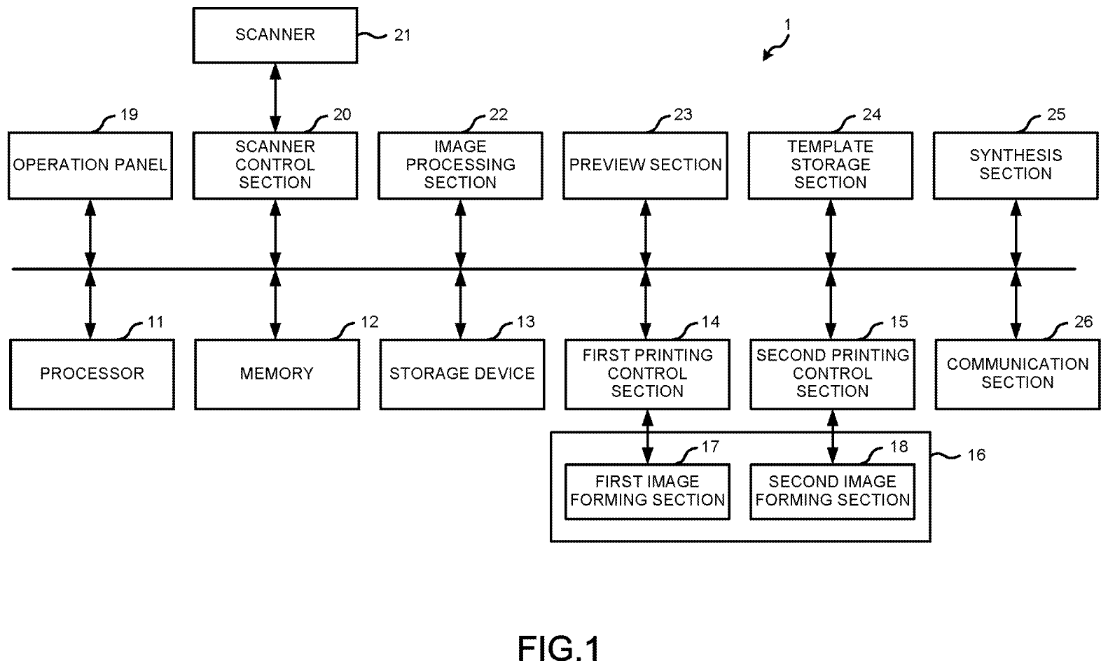

FIG. 1 is a block diagram illustrating an example of a configuration of the image forming apparatus 1 (e.g., a printer) according to at least one embodiment.

As shown in FIG. 1, the image forming apparatus 1 includes a processor 11, a memory 12, a storage device 13, a first printing control section 14, a second printing control section 15, an image forming section 16, an operation panel 19, a scanner control section 20, a scanner 21, an image processing section (image processor) 22, a preview section 23, a template storage section 24, a combination section 25 and a communication section (a communication interface) 26, and the like.

The processor 11, the memory 12, the storage device 13, the first printing control section 14, the second printing control section 15, the operation panel 19, the scanner control section 20, the image processing section 22, the preview section 23, the template storage section 24, the combination section 25 and the communication section 26 are connected to each other via a data bus or the like. The first printing control section 14 is connected to the second printing control section 15 and the image forming section 16 via a data bus or the like. The scanner control section 20 and the scanner 21 are connected to each other via a data bus or the like. The image forming apparatus 1 may further include a component as required in addition to the components shown in FIG. 1, or exclude a specific component from the image forming apparatus 1.

The processor 11, the memory 12, the storage device 13, the image forming section 16, the operation panel 19, the scanner control section 20, the image processing section 22, the preview section 23, the template storage section 24, the combination section 25 and the communication section 26 may make up a system control section.

The processor 11 (controller) has a function of controlling a printing operation of the image forming apparatus 1. The processor 11 may include an internal memory and various interfaces. The processor 11 realizes various processing by executing programs stored in the internal memory or the storage device 13 in advance.

A part of the various functions realized by the processor 11 executing the programs may be realized by a hardware circuit. In this case, the processor 11 controls the functions realized by the hardware circuit.

The memory 12 is a volatile memory. The memory 12 is a working memory or a buffer memory. The memory 12 stores various application programs based on commands from the processor 11. The memory 12 may store data necessary for executing the application programs, an execution result of the application programs, and the like.

The storage device 13 is a non-volatile memory capable of writing and rewriting data. The storage device 13 is, for example, a HDD (Hard Disk Drive), a SSD (Solid State Drive), an Electrically Erasable and Programmable Read Only Memory or a flash memory. The storage device 13 stores control programs, applications, various data, and the like according to the use of the image forming apparatus 1.

In response to a signal from the first printing control section (first printing controller) 14 and the second printing control section (second printing controller) 15, the image forming section 16 forms images on a sheet using a non-decolorable toner (non-decolorable printing material) and a decolorable toner (decolorable printing material). The image forming section 16 includes a first image forming section 17 and a second image forming section 18.

The first image forming section 17 forms an image on the sheet with the non-decolorable toner.

The second image forming section 18 forms an image on the sheet with the decolorable toner.

The configuration of the second image forming section 18 is similar to that of the first image forming section 17, and thus the description thereof is omitted.

The decolorable toner is a toner to be decolored by heating at a temperature higher than a predetermined temperature. For example, the decolorable toner is decolored when heated at a temperature higher than a fixing temperature.

The image forming section 16 fixes a toner image on the sheet by heating the sheet on which each toner image is formed using a fixing device.

The first printing control section 14 controls the first image forming section 17 in response to a signal from the processor 11.

The second printing control section 15 controls the second image forming section 18 in response to a signal from the processor 11.

The first printing control section 14 and the second printing control section 18 may be integrally formed as one printing control section.

An operator of the image forming apparatus 1 uses the operation panel 19 (input device and display) to input various instructions. The operation panel 19 transmits data of an instruction input by the operator to the processor 11. The operation panel 19 includes, for example, a keyboard, a numeric keypad, a touch panel, and the like as an operation section.

The operation panel 19 displays various information to the operator of the image forming apparatus 1. In other words, the operation panel 19 displays a screen showing various information based on a signal from the processor 11. The operation panel 29 includes, for example, a liquid crystal display as a display section.

The scanner 21 (interface) optically scans a document to reads an image of the document (the document image). The scanner 21 reads the image of the document as a color image or a monochrome image. The scanner 21 includes a sensor row formed in a main scanning direction. The scanner 21 moves the sensor row in a sub-scanning direction to read the whole document. The scanner 21 may read the whole document by moving the document.

The scanner control section 20 controls the scanner 21 in response to a signal from the processor 11. For example, the scanner control section 20 sends the document image acquired by the scanner 21 to the image processing section 22.

The image processing section 22 processes an image to be printed on the sheet. For example, the image processing section 22 compresses or decompresses the document image. The image processing section 22 may function as a page memory for storing the document image.

The preview section 23 generates a preview image of an image to be printed on the sheet. The preview section 23 generates a combined image obtained by combining the document image and the auxiliary image as a preview image. In other words, the preview section 23 displays a printing output when the document image and the auxiliary image are combined. The auxiliary image is described later.

The template storage section 24 (memory) stores a template of the auxiliary image to be presented to the user. The template storage section 24 scores the template of the auxiliary image as an image to be displayed on the operation panel 19. The template storage section 24 may be contained in the memory 12.

The auxiliary image is used for assisting a post-processing (finishing processing) of the sheet on which an image is printed. For example, the finishing processing includes a punching processing, a margin for pasting processing, a stapling processing, a cutting processing or a folding processing (for example, Z-folding or folding in three) of the sheet, or the like.

The auxiliary image is an image for assisting the finishing processing. For example, the auxiliary image is an additional line (hole punching an additional line) to match a center of the hole punching, a margin for pasting showing a margin for pasting area (additional line for a margin for pasting), a dashed line indicating a position of stapling, a cutting line, an additional line for folding (for example, a mountain folding line or a valley folding line) and the like.

The contents of the finishing processing or the auxiliary image are not limited to specific configurations.

The combination section 25 combines the auxiliary image with the document image. For example, the combination section 25 acquires bitmap data making up the auxiliary image. For example, the bitmap data may be data in which a color of a dot is associated with a coordinate. Based on the bitmap data of the auxiliary image, the combination section 25 generates a combined image by combining the auxiliary image with the document image.

The communication section 26 (interface) is an interface for transmitting and receiving data to and from an external device. The communication section 26 supports a LAN connection, for example.

Next, the function realized by the image forming apparatus 1 is described. The function realized by the image forming apparatus 1 is realized by the processor 11 executing a program stored in the storage device 13.

Here, the function may be realized when the image forming apparatus 1 combines an additional line for hole punching and an additional line for folding as the auxiliary images with the document image.

First, the processor 11 has a function of acquiring the document image.

For example, the processor 11 acquires the document image through the scanner 21. The user sets a document on the scanner 21 to input an operation for reading the document to the operation panel 19. The processor 11 acquires the document image by reading the document in responses to the operation.

The processor 11 may acquire the document image from an external device through the communication section 26.

The processor 11 may acquire the document image from a memory set in the image forming apparatus 1 or the like.

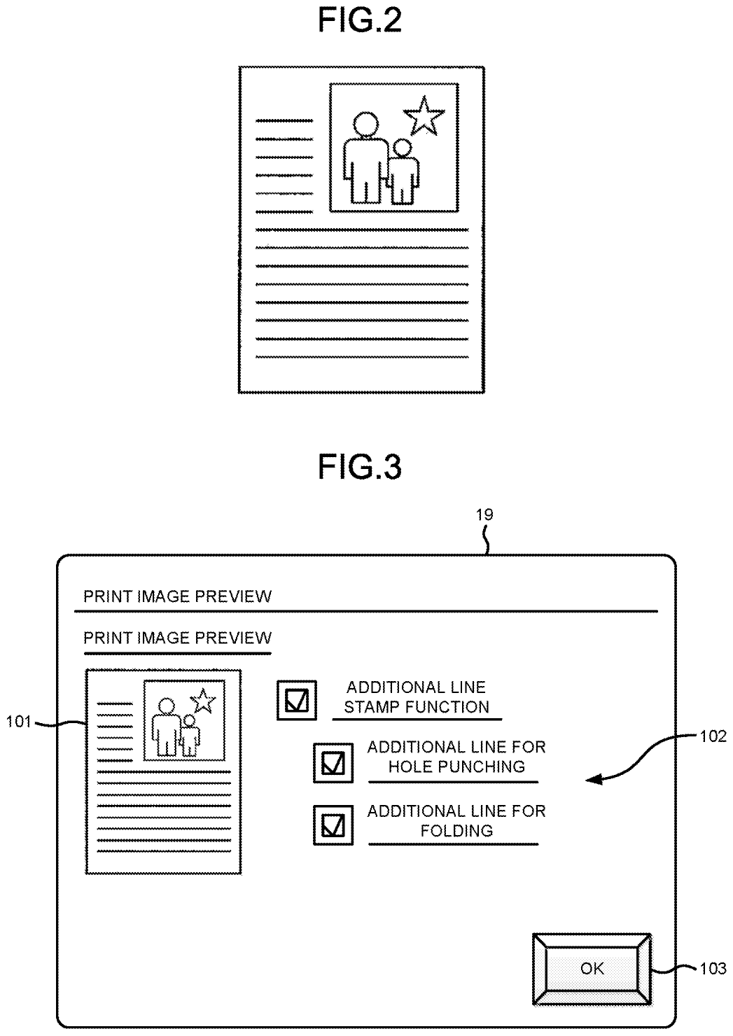

FIG. 2 shows an example of the document image acquired by the processor 11. As shown in FIG. 2, here, it is assumed that the document is vertically placed.

Furthermore, the processor 11 has a function of receiving a selection for the auxiliary image to be combined with the document image.

FIG. 3 shows an example of a screen for the processor 11 to receive a selection for the auxiliary image.

As shown in FIG. 3, the operation panel 19 displays a preview area 101, a selection area 102, and an icon 103 based on a signal from the processor 11.

In the example shown in FIG. 3, the preview area 101 is yet on the left side of the operation panel 19. The preview area 101 displays a preview of the image (print image) to be printed. Here, the preview area 101 displays the document image.

The selection area 102 is set at a center of the operation panel 19. The selection area 102 is used for inputting whether to print the additional line for hole punching or the additional line for folding as the auxiliary image. In the example shewn in FIG. 3, the selection area 102 displays a check box indicating whether to print the additional line for hole punching and a check box indicating whether or not to print the additional line for folding.

The icon 103 is set at the lower right portion of the operation panel 19. The icon 103 is used for determining whether to print the additional line for hole punching or the additional line for folding. If the icon 103 is tapped, the processor 11 determines whether to print the additional line for hole punching or the additional line for folding according to the state of the check box in the selection area 102.

Next, a case in which the processor 11 receives a selection on the additional line for hole punching is described. For example, it is assumed that the processor 11 detects a tap to the icon 103 in a state in which the check box of the additional line for hole punching is checked in the selection area 102.

The processor 11 receives the selection on the additional line for hole punching.

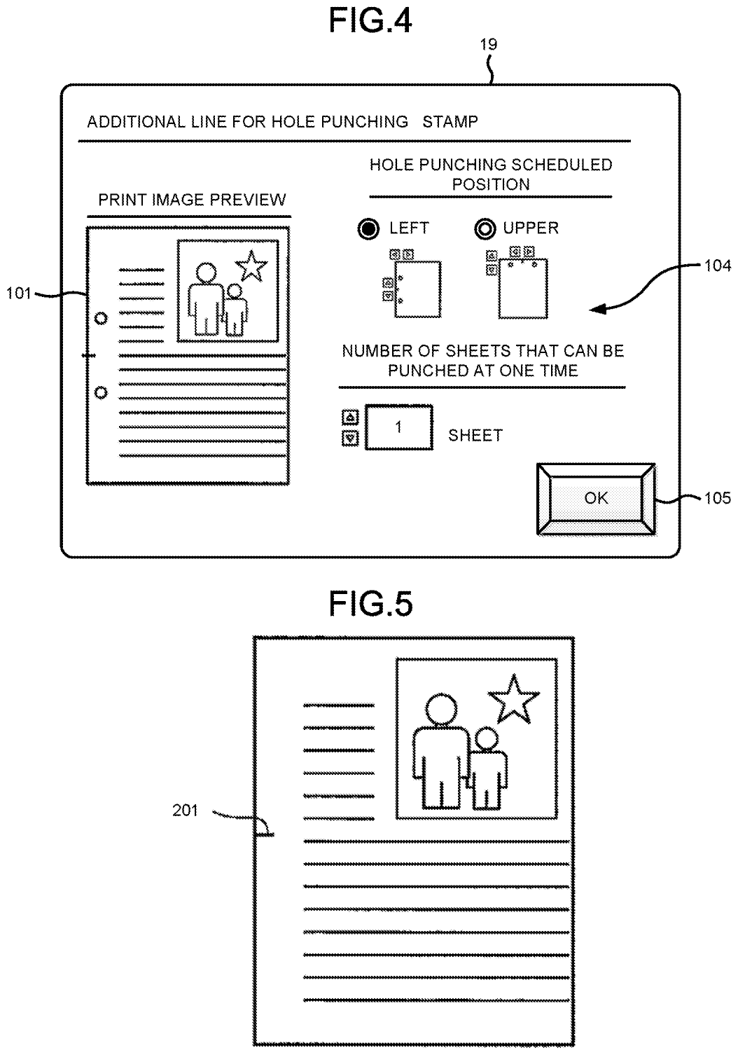

FIG. 4 shows an example of a screen for receiving the selection on the additional line for hole punching. As shown in FIG. 4, the operation panel 19 displays the preview area 101, a selection area 104, and an icon 105.

The selection area 104 is an area for inputting the selection on the additional line for hole punching. Here, the selection area 104 receives a “hole punching scheduled position” and “the number of sheets that can be punched at one time”.

The “hole punching scheduled position” receives an input of a position where a hole is punched on the sheet through hole punching processing. Here, the “hole punching scheduled position” receives a selection from the left end or the upper end of the sheet.

The hole punching scheduled position and an additional line for hole punching can be adjusted by touching or pushing the direction key shown on FIG. 4.

The “number of sheets that can be punched at one time” receives the input of the number of sheets on which the hole can be punched at one time through the hole punching processing used by the user. For example, the processor 11 prints a combined image obtained by combining the additional line for hole punching on the sheet for each sheet.

If the selection is changed, the processor 11 updates the preview area 101. For example, if the “hole punching scheduled position” is selected in the selection area 104, the processor 11 acquires a template of the additional line for hole punching corresponding to the “hole punching scheduled position” from the template storage section 24. Upon acquiring the template, the processor 11 acquires a preview image obtained by combining the document image with the template using the preview section 23. Upon acquiring the preview image, the processor 11 displays the preview image in the preview area 101.

FIG. 5 shows an example of a sheet printed by the image forming apparatus. In the example shown in FIG. 5, the processor 11 receives the selection on the left end of the sheet as the hole punching scheduled position. As shown in FIG. 5, the sheet includes an additional line for hole punching 201. The additional line for hole punching 201 is drawn horizontally at the center of the left end of the sheet.

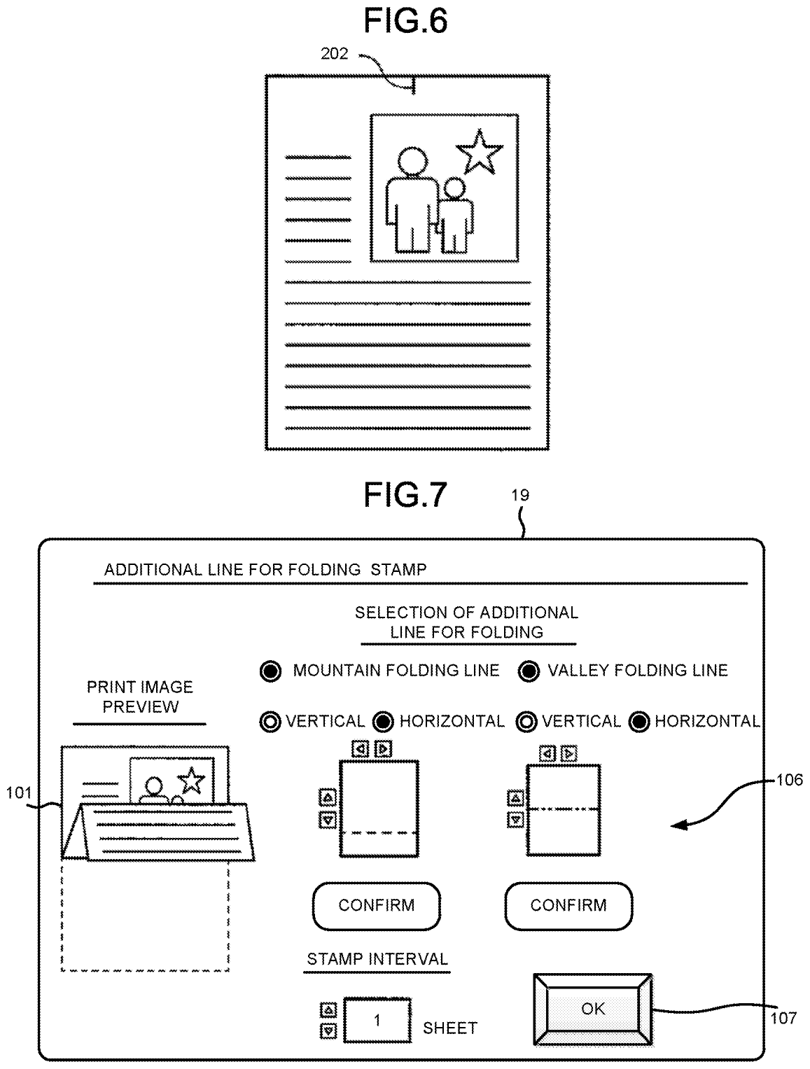

FIG. 6 shows another example of the sheet printed by the image forming apparatus. In the example shown in FIG. 6, the processor 11 receives the selection on the upper end of the sheet as the hole punching scheduled position. As shown in FIG. 6, the sheet has an additional line for hole punching 202. The additional line for hole punching 202 is drawn vertically at the center of the upper end or the sheet.

The icon 105 is used for confirming selection on the additional line for hole punching as the auxiliary image. If the icon 105 is tapped, the processor 11 determines the selection on the additional line for hole punching according to the content input in the selection area 104.

Next, a case in which tie processor 13 receives the selection on the additional line for folding is described. For example, it is assumed that the processor 11 detects a tap to the icon 103 with the check box of the additional line for folding checked in the selection area 102.

The processor 11 receives an input of settings relating to the additional line for folding.

FIG. 7 shows an example of a screen for receiving a selection on the additional line for folding by the processor 11. As shown in FIG. 7, the operation panel 19 displays the preview area 101, a selection area 106, and an icon 107.

The selection area 106 is an area for inputting the selection on the additional line for folding. Here, the selection area 106 receives “selection on additional line for folding” and “stamp interval”.

The “selection on additional line for folding” receives a selection on the additional line for folding to combine the document image as the auxiliary image.

Here, “the selection on additional line for folding” receives a selection in a type (mountain folding line or valley folding line), an orientation (horizontal or vertical) and a position of the additional line for folding.

The “stamp interval” receives the number of sheets as an interval between the sheet on which the additional line for folding is printed and the sheet on which the additional line for folding is printed next. For example, the processor 11 prints a combined image obtained by combining the additional line for folding on the sheet at an interval corresponding to the number of sheets which is input in the “stamp interval”.

If the selection is changed, the processor 11 updates the preview area 101. For example, if the selection on the additional line for folding is input in the selection area 106, the processor 11 acquires a template of the additional line for folding selected from the template storage section 24. Upon acquiring the template, the processor 11 acquires a preview image obtained by combining the document image with the template using the preview section 23. Upon acquiring the preview image, the processor 11 displays the preview image in the preview area 101. The processor 11 may display an animation showing how to fold the sheet according to the additional line for folding.

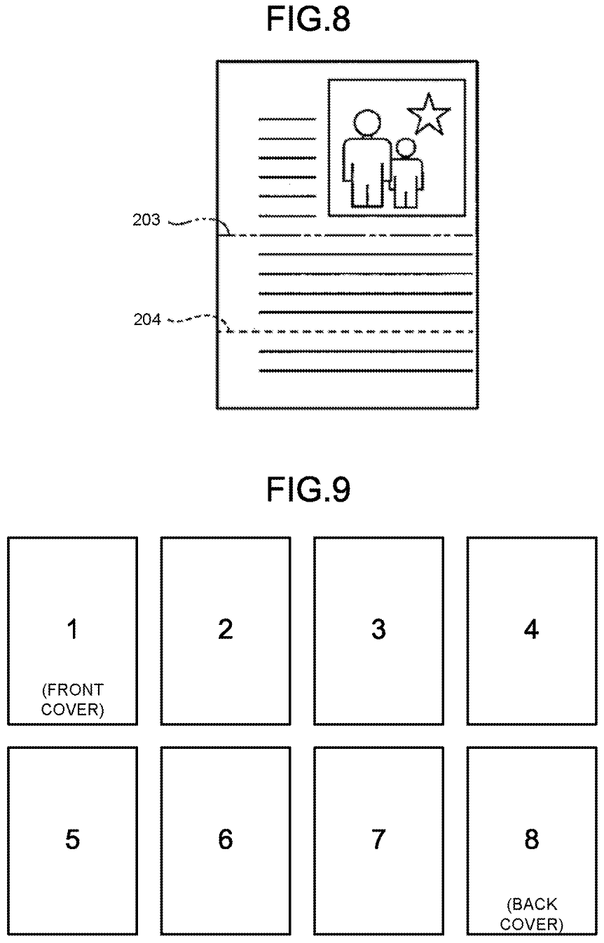

FIG. 8 shows an example of the sheet printed by the image forming apparatus. In the example shown in FIG. 8, the processor 11 receives the selection on the mountain folding line at a predetermined position and the valley folding line at a predetermined position as the additional line for folding. As shown in FIG. 8, the sheet has a valley folding line 203 and a mountain folding line 204.

The valley folding line 203 is formed from one side to the other side in the horizontal direction at the center of the sheet The mountain folding line 204 is formed from one side to the other side in the horizontal direction at the bottom of the sheet.

The icon 207 is used for confirming the selection on the additional line for folding as the auxiliary image. If the icon 107 is tapped, the processor 31 determines the selection on the additional line for folding according to the content input in the selection area 106.

The processor 11 may receive a selection on both the additional line for hole punching and the additional line for folding.

The processor 11 has a function of printing the document image on the sheet with the non-decolorable toner and printing the selected auxiliary image with the decolorable toner.

For example, the processor 11 receives an input of an operation to start the printing through the operation panel 19. Upon reception of the input of the operation, the processor 11 generates the combined image by combining the document image with the auxiliary image using the combination section 25.

If the combined image is generated, the processor 11 forms the toner image of the document image in the combined image on the sheet with the non-decolorable toner using the first image forming section 17. If the toner image of the document image is formed on the sheet, the processor 11 forms the toner image of the auxiliary image of the combined image on the sheet with the decolorable toner using the second image forming section 18. If the toner image of the auxiliary image is formed on the sheet, the processor 11 fixes the toner images on the sheet by heating the sheet using a heating section of the image forming section 16.

If each toner image is fixed on the sheet, the processor 11 discharges the sheet to the outside using a conveyance section or the like.

Next, the function realized when the image forming apparatus 1 combines the additional line for folding as the auxiliary image with the document image is described.

First, the processor 11 acquires a plurality of the document images for creating a folded book. The processor 11 acquires a plurality of the document images as described above.

FIG. 9 shows an example of a plurality of the document images acquired by the processor 11. In the example shown in FIG. 9, the processor 11 acquires eight document images. In FIG. 9, page numbers 1 to 8 are assigned to the document images.

The processor 11 receives the selection on a spreading direction of the folded book as the selection on the auxiliary image.

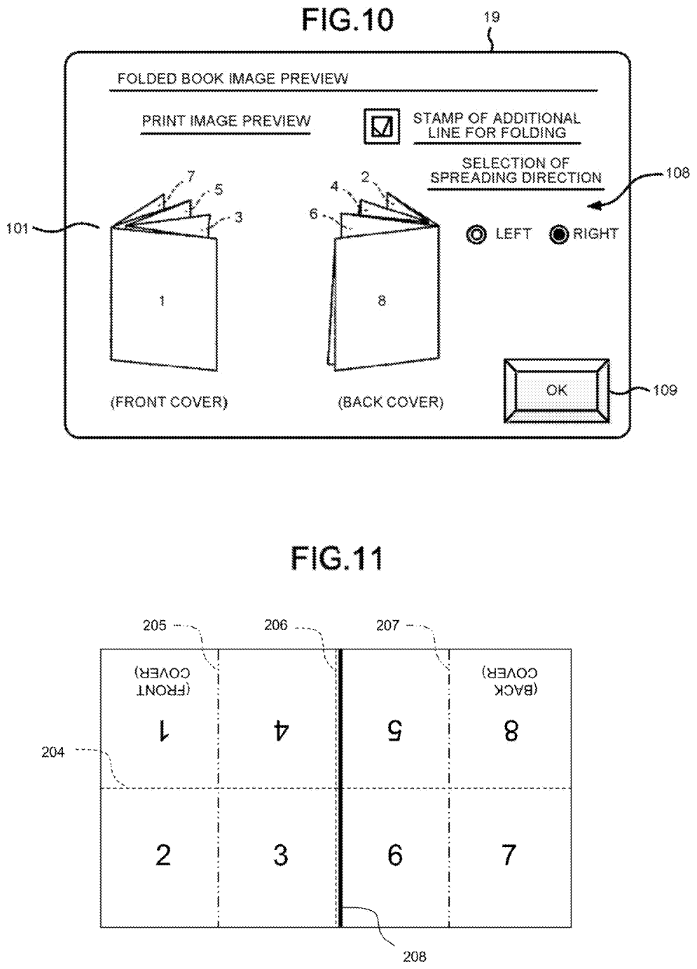

In FIG. 10, the processor 11 shows an example of a screen for receiving the selection on the fold spreading direction. As shown in FIG. 10, the operation panel 19 displays the preview area 101, a selection area 108 and an icon 109.

The preview area 101 displays a preview of the folded book in the selected spreading direction. Here, the preview area 101 displays a front cover side and a back cover side of the finished folded book.

The selection area 108 is used for inputting the selection on the spreading direction of the folded book. Here, the selection area 108 displays a radio button for inputting a selection on right-hand opening or left-hand opening.

The processor 11 updates the preview area 101 based on the selection input in the selection area 108. For example, the processor 11 updates the preview area 101 if the selection on the radio button in the selection area 108 is changed.

The icon 109 is used for confirming the selection on the auxiliary image. If the icon 109 is tapped, the processor 11 determines the selection on the auxiliary image according to the content input in the selection area 103.

Here, the auxiliary image is an image for assisting the creation of a folded book. For example, the auxiliary image includes the mountain folding line, the valley folding line and a cut line.

The processor 11 prints the document image on the sheet with the non-decolorable toner and prints the auxiliary image corresponding to the spreading direction selected by the decolorable toner.

The processor 11 prints a plurality of the document images arranged to form the folded took in the selected spreading direction with the non-decolorable toner on one sheet. The processor 11 prints the auxiliary image on the sheet with the decolorable toner. The method by which the processor 11 prints the document image and the auxiliary image is described above, and thus the description thereof is omitted.

FIG. 11 shows an example of a sheet on which the combined image is printed. FIG. 11 shows an example in the case in which a right-hand opening is selected. As shown in FIG. 11, a plurality of the document images (1 to 8) is printed on the sheet in a predetermined order and direction.

A mountain folding line 201, a valley folding line 205, a mountain folding line 206, a valley folding line 207, and a cut line 208 are printed as the auxiliary images on the sheet at predetermined positions and orientations, respectively.

Next, the function realized when the image forming apparatus 1 combines the additional line for margin for pasting as the auxiliary image with the document image.

First, the processor 11 acquires a plurality of the document images. The processor 11 acquires a plurality of the document images as described above.

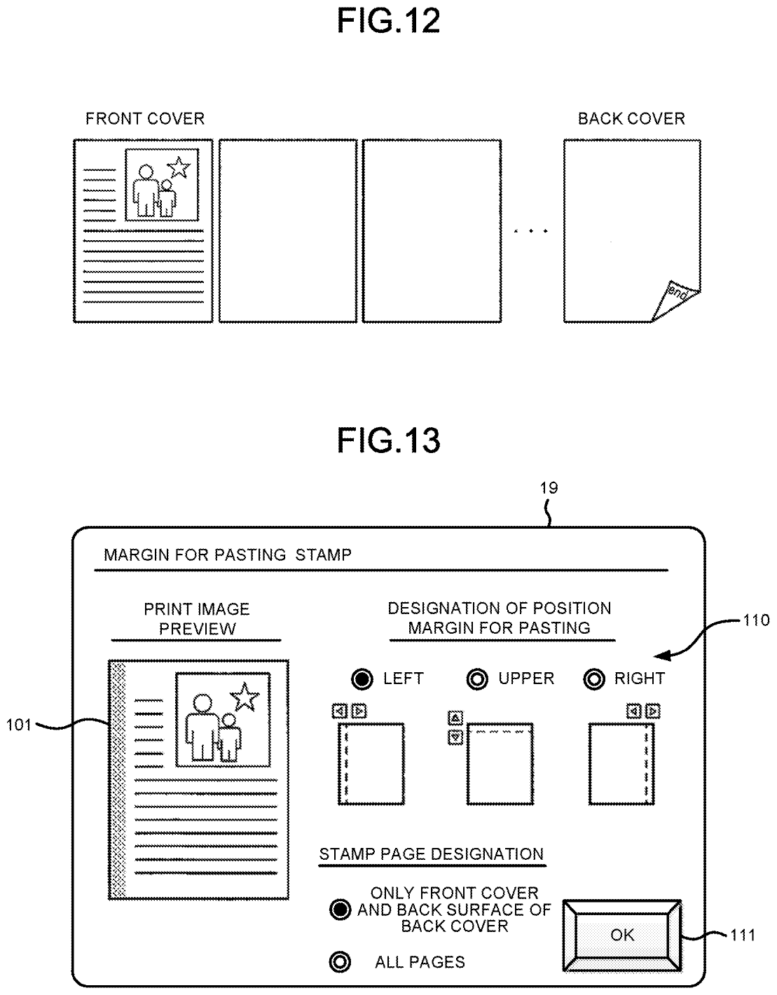

FIG. 12 shows an example of a plurality of the document images acquired by the processor 11. In the example shown in FIG. 12, the processor 11 acquires the document image on the front cover and the document image on the back cover. The processor 11 acquires the document image in addition to the front cover and the back cover.

The processor 11 receives a selection position as a selection on the auxiliary image and selection on a document to print the auxiliary image.

FIG. 13 shows an example of the screen for receiving the selection on the position of the margin for pasting and the document on which the auxiliary image is printed. As shown in FIG. 13, the operation panel 19 displays the preview area 101, the selection area 110, and the icon 112.

The preview area 101 displays the selected position of the margin for pasting and the preview of the document image on the document.

The selection area 110 is used for inputting the position of the margin for pasting and a selection on a document on which the auxiliary image is printed. In the example shown in FIG. 13, the selection area 110 receives “designation of position of margin for pasting” and “stamp page designation”.

The “designation of position of the margin for pasting” receives the input of the position of the margin for pasting. Here, the “designation of position of the margin for pasting” receives the selection among “left”, “upper” or “right”.

The “stamp page designation” receives designation of a page of the document on which the auxiliary image (additional line for margin for pasting) is printed. In this case, “stamp page designation” receives the selection from “only the front cover and the back surface of the back cover” or “all pages”.

The processor 11 updates the preview area 101 based on the selection input in the selection area 110. For example, the processor 11 updates the preview area 101 if the selection on the radio button of the selection area 110 is changed.

The icon 111 is used for confirming selection on the auxiliary image. If the icon 111 is tapped, the processor 11 determines the selection on the auxiliary image according to the content input in the selection area 120.

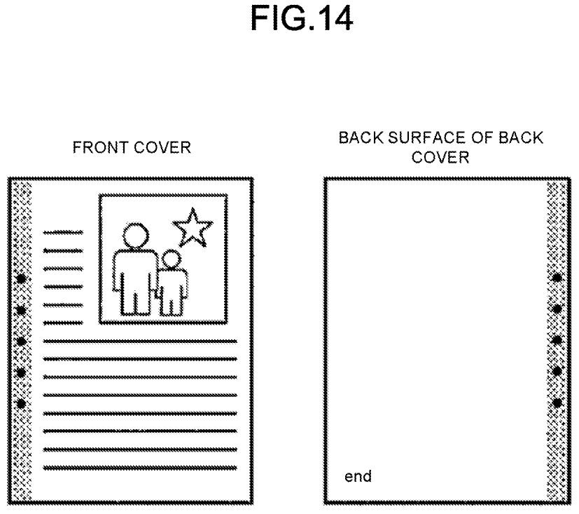

FIG. 14 shows an example of the sheet on which the combined image is printed. FIG. 14 shows an example in which “left” is selected as the “designation of position of the margin for pasting”, and “only the front cover and the back surface of the back cover” is selected as “stamp page designation”. As shown in FIG. 14, an additional line for margin for pasting is printed on the left side of the front cover and the back surface of the back cover of the document.

Next, an example of an operation by the image forming apparatus 1 is described. First, an example of the operation performed when the image forming apparatus 1 combines the additional line for hole punching and the additional line for folding as the auxiliary images with the document image is described.

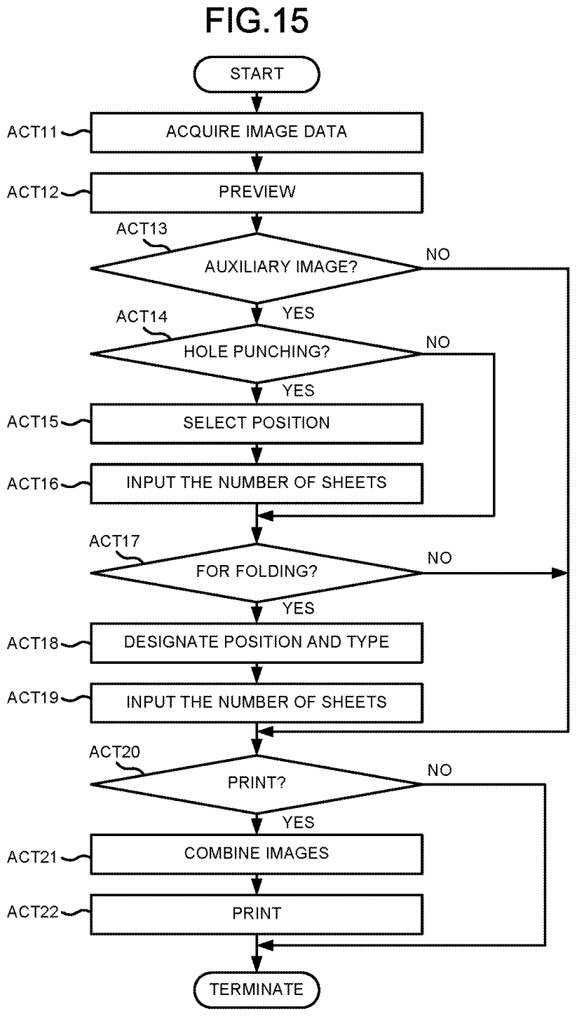

FIG. 15 is a flowchart for depicting an example of the operation performed when the image forming apparatus 1 combines the additional line for hole punching and the additional line for folding as the auxiliary images with the document image.

First, the processor 11 acquires the document image (ACT 11). Upon acquiring the document image, the processor 11 displays the preview image of the document image in the preview area 101 (ACT 12).

If the preview image is displayed, the processor 11 determines whether or not an operation for combining the auxiliary image is received (ACT 13). If it is determined that an operation for combining the auxiliary image is received (Yes in ACT 13), the processor 11 determines whether an operation for combining the additional line for hole punching is received (ACT 14).

If it is determined that the operation for combining an additional line for hole punching is received (Yes in ACT 14), the processor 11 receives thee selection on the “hole punching scheduled position” (ACT 15). The processor 11 may update the preview image.

Upon reception of the selection on the “hole punching scheduled position”, the processor 11 receives the input of the “number of sheets that can be punched at one time” (ACT 16).

If it is determined that an operation for combining the additional line for hole punching is not received (No in ACT 14) or if the input of “the number of sheets that can be punched at one time” (ACT 16) is received, the processor 11 determines whether the operation for combining the additional line for folding is received (ACT 17). If it is determined that the operation for combining the additional line for folding is received (Yes in ACT 17), the processor 11 receives a selection of the type and the position of the additional line for folding (ACT 18). The processor 11 may update the preview image.

Upon receiving the selection on the type, the orientation and the position of the additional line for folding, the processor 11 receives input of the “stamp interval” (ACT 19).

If it is determined that the operation for combining the auxiliary image is not received (No in ACT 13), if it is determined that the operation far combining the additional line for folding is not received (No in ACT 17) or if the input of the “stamp interval” is received (ACT 19), the processor 11 determines whether an operation for printing an image is received (ACT 20).

If it is determined that the operation for printing the image is received (Yes in ACT 20), the processor 11 generates a combined image by combining the auxiliary image with the document image using the combination section 25 (ACT 21).

If it is determined that the operation for combining the auxiliary image is not received (No in ACT 13), the processor 11 sets the document image as the combined image.

Upon generating the combined image, the processor 11 prints the document image using the non-decolorable toner and prints the auxiliary image using the decolorable toner on the sheet with the image forming section 16 (ACT 22).

If it is determined that the operation of printing an image is not received (an operation of canceling printing is received) (No in ACT 20), or if the image is printed on the sheet (ACT 22), the processor 11 terminates the operation.

Next, an example of the operation performed when the image forming apparatus 1 combines the additional line for folding as the auxiliary image with the document image is described.

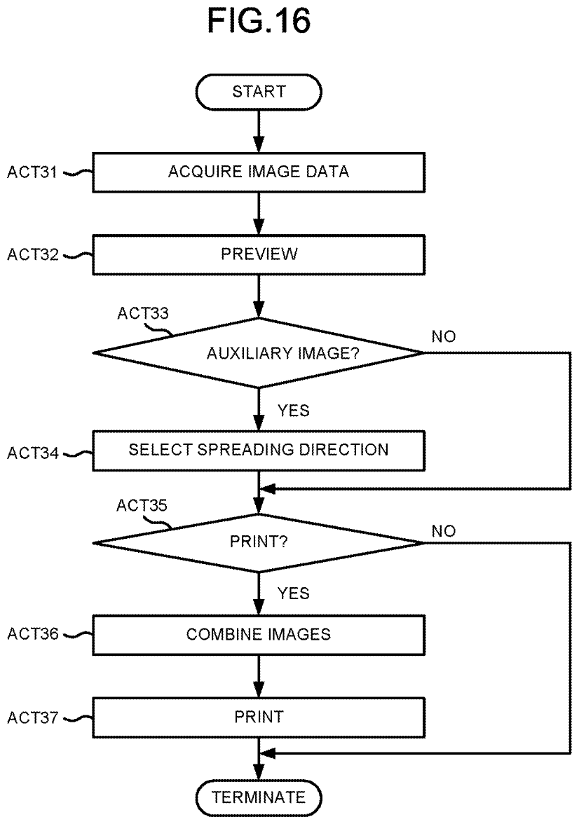

FIG. 16 is a flowchart for depicting an example of the operation performed when the image forming apparatus 1 combines the additional line tor folding as the auxiliary image with the document image.

First, the processor 11 acquires the document images of a plurality of documents (ACT 31). Upon acquiring the document image, the processor 11 displays preview image of the folded book in the preview area 101 (ACT 22).

If the preview image of the folded book is displayed, the processor 21 determines whether an operation for combining the auxiliary image is received (ACT 33). If it is determined that the operation for combining the auxiliary image is received (Yes in ACT 33), the processor 11 receives the selection on the spreading direction (ACT 34). The processor 11 may update the preview image.

If it is determined that the operation of combining the auxiliary image is not received (No in ACT 33) or if the selection on the spreading direction is received (ACT 34), the processor 11 determines whether an operation for printing the image is received (ACT 35).

If it is determined that the operation for printing an image is received (Yes in ACT 35), the processor 11 generates a combined image by combining the auxiliary image with the document image using the combination section 25 (ACT 36). If it is determined that the operation for combining the auxiliary image is not received (No in ACT 33), the processor 11 sets the document image as the combined image.

If the combined image is generated, the processor 11 prints the document image using the non-decolorable toner and prints the auxiliary image using the decolorable toner on the sheet with the image forming section 16 (ACT 37). If it is determined that the operation for printing the image is not received (an operation of canceling the printing is received) (No in ACT 35), or if the image is printed on the sheet (ACT 37), the processor 11 terminates the operation.

Next, an example of operation performed when the image forming apparatus 1 combines the additional line for margin for pasting as the auxiliary image with the document image is described.

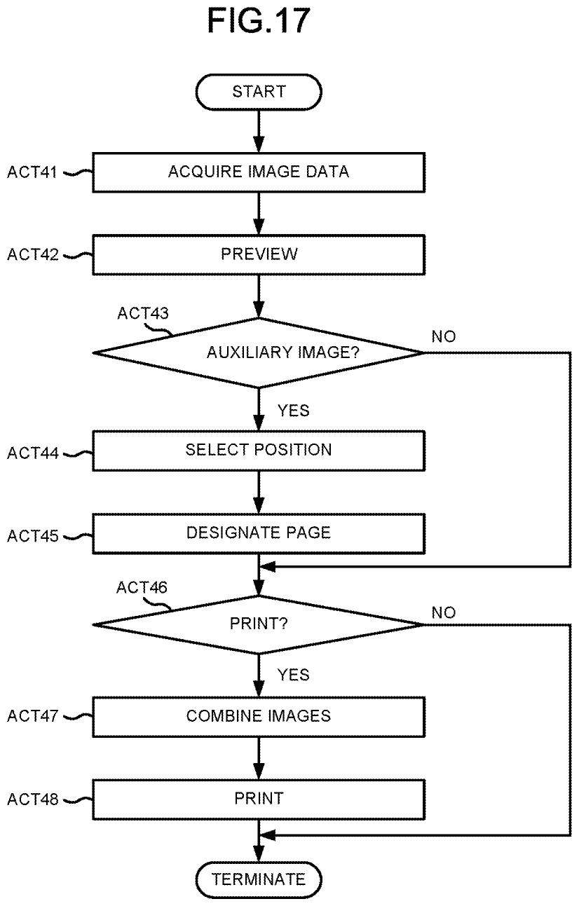

FIG. 17 is a flowchart for depicting an example of the operation performed when the image forming apparatus 1 combines the additional line for margin for pasting as the auxiliary image with the document image.

First, the processor 11 acquires the document images of a plurality of documents (ACT 41). Upon acquiring the document images, the processor 11 displays preview image in the preview area 101 (ACT 42).

If the preview image is displayed, the processor 11 determines whether an operation for combining the auxiliary image is received (ACT 43), If it is determined that the operation for combining the auxiliary image is received (Yes in ACT 43), the processor 11 receives a selection for the position of the margin for pasting (ACT 44). The processor 11 may update the preview image.

If the position of the margin for pasting is received, the processor 11 receives the input of a page of the document on which the additional line tor margin for pasting is printed (ACT 45).

If it is determined that an operation for combining the auxiliary image is not received (No in ACT 43), or if the input of a page of the document on which the additional line for margin for pasting is printed is received (ACT 45), the processor 11 determines whether the operation for printing an image is received (ACT 46).

If it is determined that the operation for printing the image is received (Yes in ACT 46), the processor 11 generates a combined image by combining the auxiliary image with the document image using the combination section 25 (ACT 47). If it is determined that the operation for combining the auxiliary image is not received (No in ACT 43), the processor 11 sets the document image as the combined image.

If the combined image is generated, the processor 11 prints the document image using the non-decolorable toner and prints the auxiliary image using the decolorable toner on the sheet with the image forming section 16 (ACT 48). If it is determined that the operation of printing the image is not received (an operation of canceling the printing is received) (No in ACT 46), or if the image is printed on the sheet (ACT 48), the processor 11 terminates the operation.

Any one of the first printing control section 14, the second printing control section 15, the scanner control section 20, the image processing section 22, the preview section 23, the template storage section 24 and the combination section 25 may be an ASIC (application specific integrated circuit), for example.

The first printing control section 14, the second printing control section 15, the scanner control section 20, the image processing section 22, the preview section 23, the template storage section 24 and the combination section 25 may be realized by the processor 11.

The auxiliary image is not limited to an image of a line. For example, the auxiliary image may be a mark or the like. The structure of the auxiliary image is not limited to a specific configuration.

The printing material may be toner or ink in some embodiments.

The image forming apparatus configured as described above prints the document image using the non-decolorable toner and prints the auxiliary image using the decolorable toner in the finishing process. As a result, with the image forming apparatus, the user can efficiently perform the finishing processing. Therefore, the image forming apparatus can complete the finishing processing without using a finisher or another device.

The auxiliary image is formed with the decolorable toner. Therefore, the image forming apparatus can print an erasable auxiliary image on the sheet. As a result, the auxiliary image can be decolorized or erased after post-processing (finishing processing) such as hole punching processing or processing of folding a sheet in three.

While certain embodiments have been described, these embodiments have been presented by way of example only, and are not intended to limit the scope of invention. Indeed, the novel apparatus and methods described herein may be embodied in a variety of other forms. Furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. A printer, comprising:
an image forming apparatus configured to form images with non-decolorable printing material and decolorable printing material;
a scanner configured to acquire a document image;
a memory configured to store an auxiliary image relating to post-processing; and
a controller configured to cause the image forming apparatus to print the document image with the non-decolorable printing material on a medium by using the image forming apparatus, and to print the auxiliary intake with the decolorable printing material on the medium on which the document image is printed by using the image forming apparatus.

2. The printer according to claim 1, further comprising:
an operation panel through which a selection for the auxiliary image is inputted, wherein
the controller is configured to print the auxiliary image selected through the operation panel on the medium.

3. The printer according to claim 1, further comprising:
a display configured to display an image, wherein
the controller is configured to display an image indicating a printing output obtained by combining the document image with the auxiliary image on the display.

4. The printer according to claim 1, further comprising:
an operation panel through which a number of sheets is inputted, the number of sheets being an interval between the medium on which the auxiliary image is printed and a medium on which the auxiliary image is printed next, wherein
the controller is configured to print the auxiliary image on the medium at an interval corresponding to the inputted number of sheets.

5. The printer according to claim 2, wherein
the auxiliary image includes an additional line for hole punching used for punching a hole, and
the controller is configured to receive a selection for a position for punching a hole through the operation panel, and to print the auxiliary image according to the selection.

6. The printer according to claim 1, wherein
the auxiliary image comprises at least one of a mountain folding line, a valley folding line, a cut line or an additional line for margin for pasting.

7. The printer according to claim 1, wherein
the controller is configured to acquire a plurality of document images, print the plurality of document images arranged to create a folded book on the medium, and print the auxiliary image for creating the folded book of the plurality of the document images on the medium.

8. The printer according to claim 1, wherein
the non-decolorable printing material is a non-decolorable toner, and
the decolorable printing material is a decolorable toner.

9. An image forming method, including:
acquiring a document image;
printing the document image with a non-decolorable printing material on a medium; and
printing an auxiliary image relating to a post-processing operation with a decolorable printing material on the medium on which the document image is printed.

10. The method according to claim 9, further comprising:
receiving a selection for the auxiliary image, and
printing the selected auxiliary image on the medium.

11. The method according to claim 9, further comprising:
displaying an image indicating a printing output obtained by combining the document image with the auxiliary image.

12. The method according to claim 9, further comprising:
receiving an input of a number of sheets, the number of sheets being an interval between the medium on which the auxiliary image is printed and a medium on which the auxiliary image is printed next, and
printing the auxiliary image on the medium at an interval corresponding to the inputted number of sheets.

13. The method according to claim 10, further comprising:
receiving a selection for a position for punching a hole, and printing the auxiliary image according to the selection,
wherein the auxiliary image includes an additional line for hole punching used for punching the hole.

14. The method according to claim 9, wherein
the auxiliary image comprises at least one of a mountain folding line, a valley folding line, a cut line or an additional line for margin for pasting.

15. The method according to claim 9, further comprising:
acquiring a plurality of document images, printing the plurality of document images to create a folded book on the medium, and printing the auxiliary image for creating the folded book of the plurality of the document images on the medium.

16. The method according to claim 9, wherein
the non-decolorable printing material is a non-decolorable toner, and
the decolorable printing material is a decolorable toner.

17. The printer according to claim 1, wherein the controller is configured to cause the image forming apparatus to form a combined image including the document image and the auxiliary image on the medium.

18. The method according to claim 9, further comprising printing a combined image including the document image and the auxiliary image on the medium.
